(19) United States
(12) Patent Application Publication
(10) Pub. No.: US 2008/0299332 A1
(43) Pub. Date: Dec. 4, 2008

(54) Optical Diffraction Structure Transfer Sheet and Method for Manufacturing the Same

(76) Inventor: Tetsuya Matsuyama, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/629,265

(22) PCT Filed: Jun. 8, 2005
(86) PCT No.: PCT/JP2005/010515

§ 371 Date: Dec. 12, 2006

(30) Foreign Application Priority Data
Jun. 14, 2004 (JP) 2004-175068

(51) Int. Cl. B44F 1/00; B05D 3/06

(52) U.S. Cl. 428/29; 427/532

(57) ABSTRACT

An optical diffraction structure transfer sheet which can specify the optical diffraction structure transfer sheet of a source of transfer from optical diffraction structure used in an image. The optical diffraction structure transfer sheet has a transfer layer 12 where within optical diffraction structure having a first pattern is formed. The transfer layer is layered on a substrate sheet, and the optical diffractions structure has a pattern area where a second pattern different from the first pattern is formed. The pattern area is incorporated into the optical diffraction structure in a size invisible to naked eye.

### TECHNICAL FIELD

The present invention relates to an optical diffraction structure transfer sheet and a method for manufacturing the same.

### BACKGROUND ART

An optical transfer sheet where a transfer layer where optical diffraction structure having a predetermined pattern is formed on a substrate sheet has been already known (for example, see a patent document 1). This optical diffraction structure transfer sheet is used for forming an image including optical diffraction structure.

Patent Document 1: Patent application laid-open disclosure number 2003-098455

### DISCLOSURE OF INVENTION

### Problems to be Solved by the Invention

However, the technique to specify an optical diffraction structure transfer sheet based on the optical diffraction structure in an image formed using the optical diffraction structure transfer sheet has not been provided.

Therefore, the present invention aims at providing an optical diffraction sheet and a method for manufacturing the same which can be specified based on the optical diffraction structure in an image formed using the optical diffraction structure transfer sheet.

An optical diffraction structure transfer sheet of the present invention solves the above problems. The optical diffraction structure transfer sheet is an optical diffraction structure transfer sheet in which a transfer layer where optical diffraction structure having a first pattern is formed, is layered on a substrate sheet, wherein the optical diffraction structure has a pattern area where a second pattern different from the first pattern is formed, the pattern area being incorporated into the optical diffraction structure in a size invisible to naked eyes.

According to the optical diffraction structure transfer sheet of the invention, the pattern area which is invisible to naked eyes is incorporated into the optical diffraction structure in the image created by the optical diffraction structure transfer sheet. By corresponding a specified pattern of the pattern area with a specified optical diffraction structure transfer sheet, even if the image which looks like a usual one at the first glance, the optical diffraction structure transfer sheet corresponding to the optical diffraction structure included in the image can be specified, by enlarging the optical diffraction structure included in the image with a microscope or the like to discriminate the pattern. Thereby, for example, if an image is forged, the optical diffraction structure transfer sheet used to create the forgery image can be specified. That makes specifying the image forger easy

When a transfer unit which is a unit of transferring the transfer layer is known in advance, if the pattern area is incorporated into the optical diffraction structure so that at least one pattern area is transferred for every transfer unit, even if any part of the transfer layer is transferred, the optical diffraction structure transfer sheet to be a source of transfer can be specified by the pattern area. The first pattern of the optical diffraction structure includes an even convexoconcave pattern to generate an even pattern and a convexoconcave pattern to generate a predetermined shape. The second pattern of the pattern area can be any type pattern as long as discriminated to be different from the first pattern.

The wording “incorporated into” includes the case that the optical diffraction structure where the first pattern is formed and the pattern area where the second pattern is formed are the same in material, but different in only surface figure. The wording “optical diffraction structure” means a structure which can represent a predetermined pattern using diffraction of light, and includes so-called diffraction grating where convexoconcave pattern is formed evenly and so-called hologram where interference fringe to generate a predetermined shape is formed.

With respect to the optical diffraction structure transfer sheet of the present invention, the second pattern may be different from the first pattern in a diffraction direction of light. Thereby, the diffraction direction of light can be caused to discriminate the pattern area, and the optical diffraction structure transfer sheet which has been used for the pattern area sheet can be specified. Also, the second pattern may be different from the first pattern in a length between adjacent interference fringes. Thereby, the length between interference fringes can be caused to discriminate the pattern area, and the optical diffraction structure transfer sheet which has been used for the pattern area sheet can be specified. If the first pattern is optical diffraction grating, for example, the second pattern can be determined by changing a diffraction grating pitch or a value of called spatial frequency. As mentioned above, the second pattern can be a pattern which is different from the first pattern in a pattern type, a pitch, or/and a direction.

In the optical diffraction structure transfer sheet, the pattern areas each of which has the second pattern equally, may be incorporated into the optical diffraction structure. Thereby, as all of the pattern areas incorporated into the optical diffraction structure have the same pattern, the formation and discrimination of the pattern areas becomes easier.

Moreover, the plural pattern areas may be incorporated in accordance with a predetermined regularity in the optical diffraction structure having a plane pattern. Thereby, as the plural pattern areas are arranged in accordance with a predetermined regularity, in the case that the convexoconcave pattern of optical diffraction structure is an even pattern, the even design represented by the even pattern is not interfered. “Predetermined regularity” means a regularity with respect to a position where to arrange each of the pattern areas.

A method for manufacturing an optical diffraction structure transfer sheet of the present invention solves the above problems. The method is a method for manufacturing an optical diffraction structure transfer sheet in which a transfer layer where optical diffraction structure having a first pattern is formed, is layered on a substrate sheet, wherein the process of manufacturing the transfer process includes a first transfer process and a second transfer process, the first transfer process for transferring the first pattern to the melt layer by the steps: superposing an object having a melt layer layered on a substrate layer and a first original plate where optical diffraction structure having the first pattern; irradiating energy beam to a portion of superposition to melt the melt layer by heat based on the energy beam; and moving the energy beam, the second transfer process for transferring a second pattern to the melt layer with a size invisible to naked eyes by the steps: the melt layer of the object where the first pattern is transferred and a second original plate having the second pattern different from the first pattern; irradiating energy beam to a portion of superposition to melt the melt layer by heat based of the energy beam; and moving the energy beam, and further includes a process for layering the object onto the substrate sheet as the transfer layer.

By the method for manufacturing an optical diffraction structure transfer sheet of the present invention, using heat of an energy beam, the optical diffraction structure transfer sheet, where the pattern area invisible to naked eyes is incorporated into the optical diffraction structure forming the transfer layer, can be manufactured. This manufacturing method only requires to transfer the patterns already formed in the first original plate and in the second original plate to the object. Therefore, troublesome process such as an image development is not necessary. Moreover, as the energy beam heats and moves locally at an only irradiation point, the heated portion can be cooled down easily. Therefore, a special cooling installation is not necessary.

“Energy beam” includes both a beam itself having heat such as a heat beam and a beam itself not having heat. Accordingly, “heat based on the energy beam” includes both the heat by the heat of the energy beam itself and the heat generated by a reaction at the irradiation point of the energy beam, such as an activation of electron or a chemical reaction. The mode of irradiating the energy beam to the superposition of the melt layer and each original plate includes both the cases where the energy beam is irradiated to the side of melt layer and where the energy beam is irradiated to the side of original plate.

Between the first transfer process and the second transfer process, it does not matter whether the energy beam is the same or not. The mode that the object after the first process and the second process composes the optical diffraction structure transfer sheet as the transfer layer includes both the cases that a part of the object composes the sheet and that whole of the object composes the sheet.

The effects of the optical diffraction structure transfer sheet manufactured by the above manufacturing method are as noted above. The second pattern is enough to be discriminated to be different from the first pattern when the second pattern is enlarged with a microscope and the like. For example, the pattern different from the first pattern in the diffraction direction of light or in the length between the adjacent interference fringes can be the second pattern. The concepts “optical diffraction structure” and “the length between the adjacent interference fringes” are as noted above. Moreover, in the case that in the second transfer process the pattern area where to transfer the second pattern is transferred so that the pattern area is always included in a minimum unit to transfer the transfer layer, even if any portion of the transfer layer is transferred, the pattern area is always provided to a transfer destination.

### Effect of the Invention

As above described, according to the present invention, by incorporating the pattern area, which has a pattern different from the optical diffraction structure, in the optical diffraction structure forming the transfer layer in a size invisible to naked eyes, the optical diffraction structure transfer sheet which can specify a source of transfer from the optical diffraction structure used in an image can be provided.

### BRIEF DESCRIPTION OF DRAWINGS

FIG. 1 An enlarged sectional view of one embodiment of a cross-sectional surface of an optical diffraction structure transfer sheet of the present invention;

FIG. 2 An enlarged top view of a part of transfer layer of the optical diffraction structure transfer sheet showed in FIG. 1;

FIG. 3 A diagram showing a state in the first transfer process of the present embodiment;

FIG. 4 A diagram showing a surface of the first original plate to be used in the first transfer process showed in FIG. 3;

FIG. 5 A diagram showing a state in the second transfer process of the present embodiment;

FIG. 6 A diagram showing a surface of the second original plate to be used in the second transfer process showed in FIG. 5;

FIG. 7A A diagram showing another mode of the pattern area;

FIG. 7B A diagram showing another mode of the pattern area; and

FIG. 8 A diagram showing another mode of the pattern area.

### BEST MODE FOR CARRYING OUT THE INVENTION

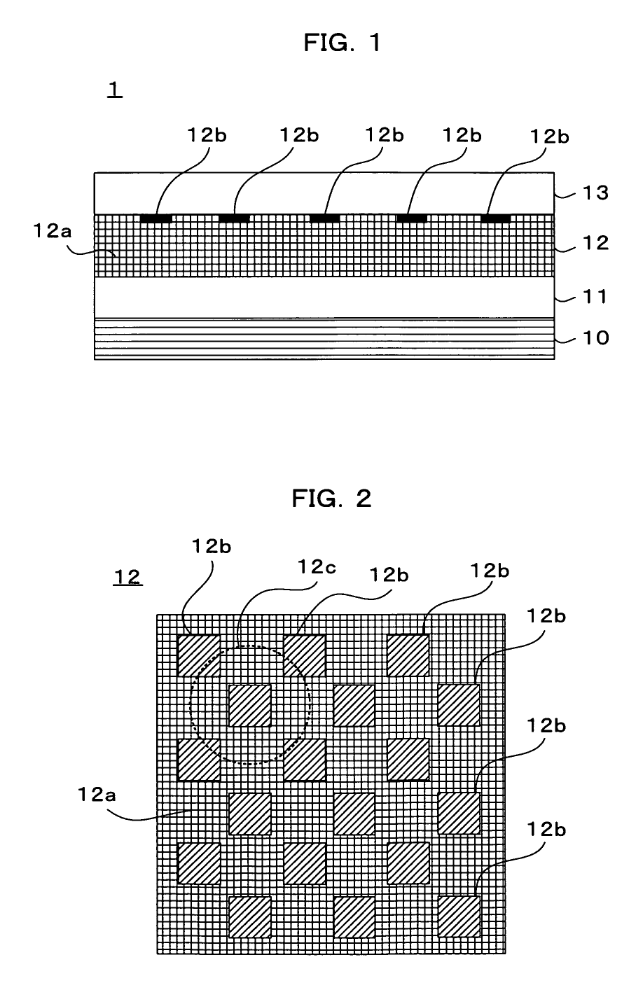

FIG. 1 is an enlarged sectional view showing one embodiment of an optical diffraction structure transfer sheet 1 of the present invention. The optical diffraction structure transfer sheet 1 is an optical diffraction structure transfer sheet for a thermal transfer printer for transferring a plane-pattern optical diffraction structure, that is, a diffraction grating where a convexoconcave pattern is formed evenly by a thermal transfer printer. In the optical diffraction structure transfer sheet1, a release layer 11, a transfer layer 12, and an adhesion layer 13 are layered on a substrate sheet 10, as showed in FIG. 1. In the transfer layer 12, plural pattern areas 12b are incorporated into an optical diffraction structure part 12a. In the optical diffraction structure part 12a, an optical diffraction structure of a convexoconcave pattern as a first pattern is formed evenly, and each of plural pattern areas 12b has a second pattern different from the convexoconcave pattern of the optical diffraction structure part 12a. In this embodiment, the first pattern of the optical diffraction structure part 12a is different from the second pattern of the pattern area 12b in a diffraction grating pitch for forming pattern.

When a part of the upper face of the transfer layer 12 is enlarged, as showed in FIG. 2, the plural pattern areas 12b . . . 12b are regularly arranged on the optical diffraction structure part 12a. In this embodiment, the plural pattern areas 12b . . . 12b are arranged in an almost reticular pattern. The size of one pattern area 12b is invisible to the naked eyes. In this embodiment, the pattern area 12b is a 20-μm-square. In FIG. 2, the pattern areas 12b are enlarged so that the pattern areas 12b become visible to the naked eyes for convenience. The material of the optical diffraction structure part 12a is the same as the material of the pattern areas 12b, buy the second pattern of the pattern areas 12b are incorporated into the first pattern of the optical diffraction structure part 12a so that the surface formation is different between the optical diffraction structure part 12a and the pattern area 12b.

At least one pattern area 12b should be included in the minimum unit of the transfer layer 12 to be transferred, but it is more preferable that the pattern areas 12b are included in the minimum unit to recognize the regularity of arrangement of the pattern areas 12b. In this embodiment, the pattern areas 12b arranged in the almost reticular pattern are included in one dot 12c to recognize the regulation. The one dot 12c is the minimum unit to be transferred by a thermal head of a thermal transfer print to be used. It is enough for the transfer layer 12 to be made of already known material as long as the pattern area 12b and the optical diffraction structure part 12a are formed as above mentioned.

The substrate sheet 10 is provided for supporting the layers to be layered thereon. The release layer 11 is provided for enhancing a release property of the transfer layer 12by heating. The adhesion layer 13 is provided for enhancing an adhesion property between the optical diffraction structure transfer sheet 11 and a transfer destination material. Each of the layers is enough to be a layer provided to a conventional optical diffraction structure transfer sheet. The adhesion layer 13 of the optical diffraction structure transfer sheet 1 having the above mentioned layers is adhered to the transfer destination, and the side of substrate sheet 10 is heated with the thermal head. Then, the adhesion layer 13 and the transfer layer 12 are unsticked and transferred onto the transfer destination. When the thermal head is controlled to draw a preferable shape, the transfer layer 12 and the like can be transferred to the transfer destination in the preferable shape for creating an image.

Next, a method for manufacturing the optical diffraction structure transfer sheet 1 showed in FIG. 1 will be described. First, the method for manufacturing the transfer layer 12 of the optical diffraction structure transfer sheet 1 will be described according to the present invention. In a process of manufacturing the transfer layer 12, the second transfer process is executed after the first transfer process. In this embodiment, in the both transfer processes, an 808-nm-semiconductor laser is used as an energy beam. The control to irradiate the semiconductor beam is realized by the computer.

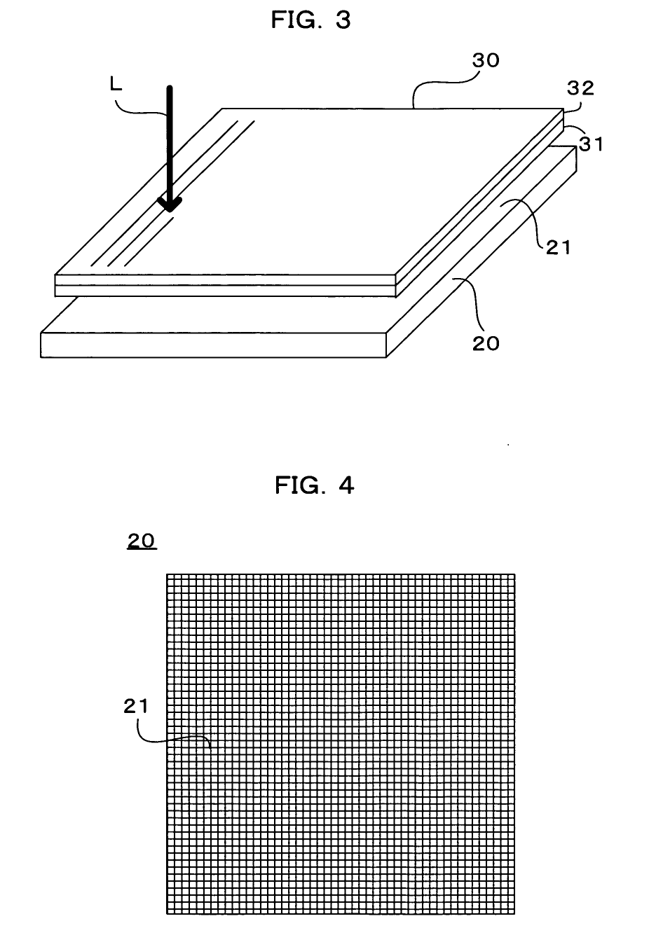

FIG. 3 is a diagram showing a state in the first transfer process, and FIG. 4 is a diagram showing a surface 21 of the first original plate 20 to be used in the first transfer process. In the surface 21 of the first original plate 20, the first pattern of the optical diffraction structure part 12a, which should be formed in the transfer layer 12, is formed. In this embodiment, the first pattern is the even convexoconcave pattern. For example, the first pattern can be a diffraction grating the pitch of which is 11.0 μm and the azimuth angle of which is 0°. In the first transfer process, the first original plate 20 and an object 30 are superposed to transfer the first pattern onto the object 30. The object 30 comprises a melt layer 31 and a substrate layer 32 for supporting the melt layer 31, and is going to be transferred onto the substrate sheet as the transfer layer after the second transfer process described later.

Wax, thermoplastic resin, and heat conversion material for enhancing conversion efficiency from light energy of the semiconductor laser to heat energy compose the melt layer 31. It is enough that the wax and the thermoplastic resin of the melt layer 31 is a solid state in a normal temperature and can melt by applying heat. It is enough that the substrate layer 32 has a heat resistance property such that the substrate layer 32 is not melted at the melt temperature of the melt layer 31.

The surface 21 where the first pattern is formed and the melt layer 31 of the object 30 should be superposed each other. The superposition is contacted closely by a vacuum contact and the like. Then, the semiconductor laser L is irradiated to the side of substrate layer 32 of the object 30, and, as showed in FIG. 3, is moved every across the object 30 by a predetermined pitch. When the melt layer 31 of the object 30 is heated to the melt temperature and is melted by the irradiated semiconductor laser L, the first pattern at the melted portion of the superposition is transferred. Consequently, the first pattern is gradually transferred to the melted melt layer 31 in accordance with the movement of the semiconductor laser L. In this way, the first pattern of the first original plate 20 can be transferred onto the whole surface of the melt layer 31 of the object 30.

In FIG. 3, the size of the first original plate 20 is equal to the size of the object 30. When the object 30 is larger than the first original plate 20, the first transfer process should be repeated by moving the first original plate 20 appropriately for transferring the first pattern onto the whole surface of the object 30. The irradiation level of semiconductor laser L, the irradiation pitch, and the move speed can be set to be suitable to the structure material of the melt layer 31 and the structure material of the first original plate 20, and can be controlled by a computer. In this embodiment, the 808-nm-semiconductor laser is controlled so that the first pattern is carved to the melt layer 31 with 0.2-μm-depth.

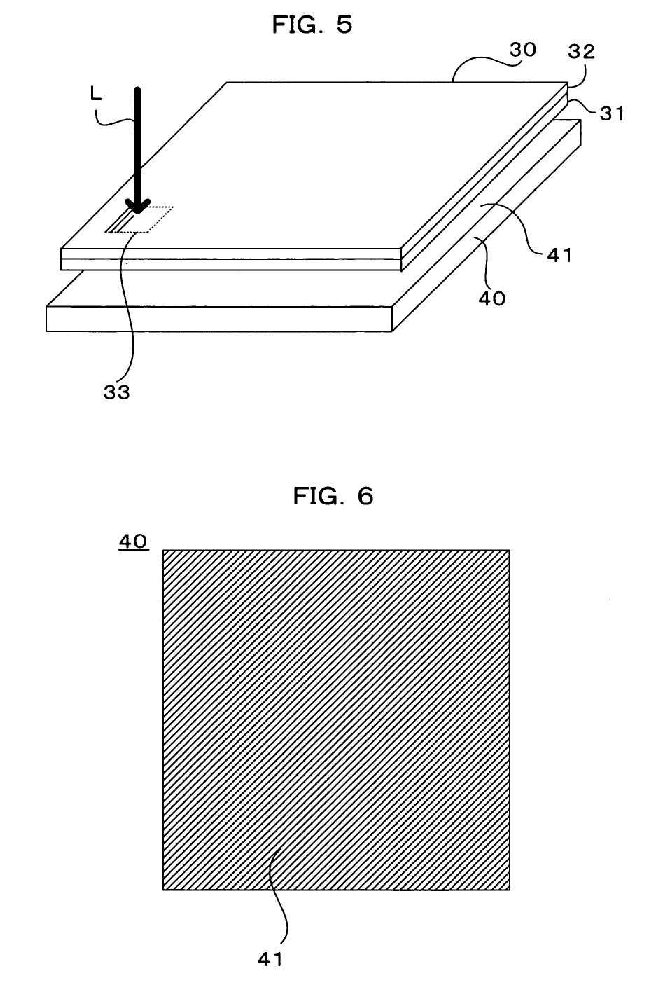

Next, the second transfer process will be described using FIG. 5. In the second transfer process, the pattern area 12b is formed. First, the second original plate 40 and the melt layer 31 of the object 30 where the first pattern is transferred by the first transfer process should be superposed each other in the same manner as the first transfer process. In the surface 41 of the second original plate 40, as showed in FIG. 6, the second pattern different from the first pattern is formed. The second pattern of this embodiment is a diffraction grating the pitch of which is 1.3 μm and the azimuth angle of which is 0°. Namely, the pitch of the diffraction grating is different between the first pattern and the second pattern. It is enough that the second pattern of this embodiment is different from the first pattern. Therefore, the second pattern can be obtained by combining any one of the pitches of diffraction grating: 1.3 μm, 1.0 μm, 0.8 μm and any one of the azimuth angles: 0°, 45°, 90°, 135°.

The semiconductor laser L is irradiated to the side of substrate layer 32 of the object 30, and moved within the 20-μm-square 33 by a predetermined irradiation pitch. One square 33 corresponds to one pattern area 12b. The irradiation level of the semiconductor laser L, the irradiation pitch, and the move speed can be set to be suitable to the material of the melt layer 31 and the material of the second original plate 40, and can be realized by a computer. In this embodiment, the 808-nm-semiconductor laser is controlled so that the second pattern is carved to the melt layer 31 with 0.2-μm-depth like the first transfer process.

And, the second pattern is transferred onto the object 30 in the manner mentioned above, so that the plural pattern areas 12b . . . 12b are formed regularly onto the object 30 in an almost reticular pattern. The adjacent pattern areas 12b . . . 12b should be transferred with a space between them for including suitable number of pattern areas 12b within one dot 12c to be printed by a thermal transfer printer to be used, so that it can be recognized that the pattern areas 12b are arranged in an almost reticular pattern. The space between the adjacent pattern areas 12b . . . 12b can be also set in advance, and can be controlled by a computer. The dot diameter of this embodiment is 80 μm.

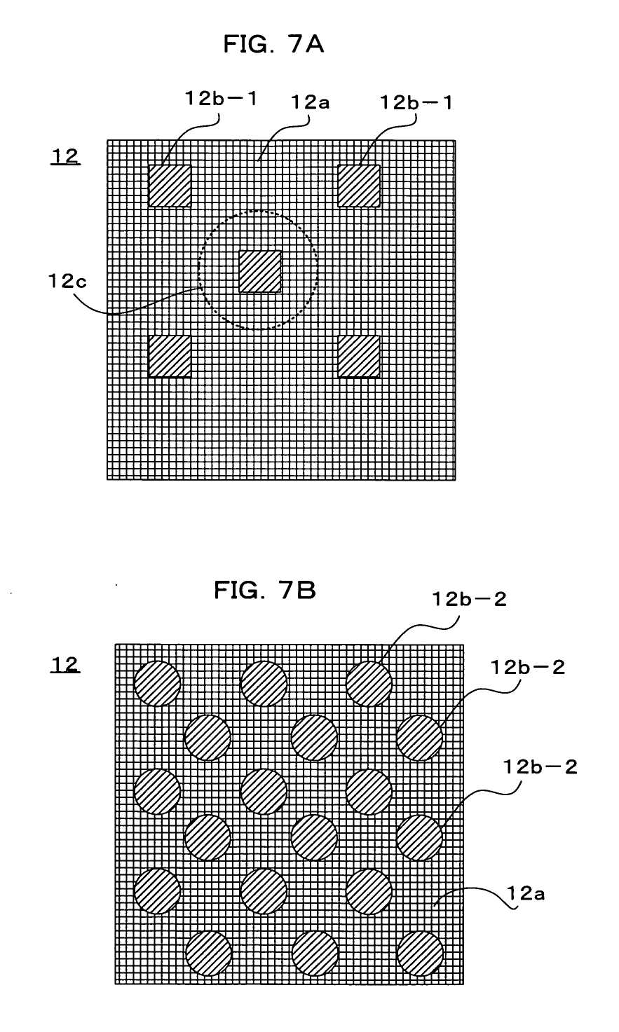

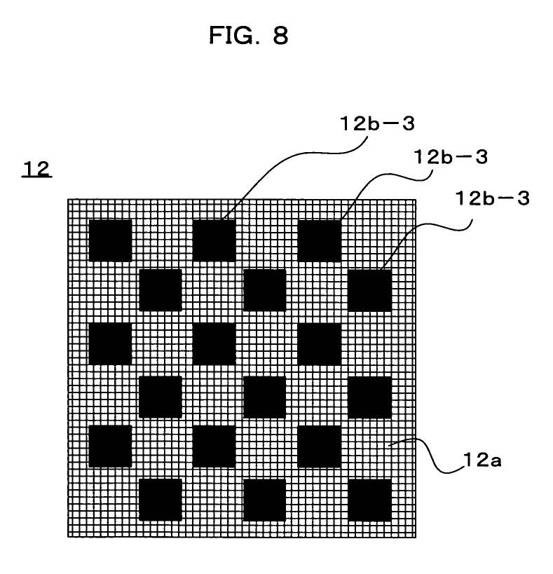

By the first transfer process and the second transfer process, the optical diffraction structure part 12a where the plural pattern areas 12b . . . 12b are incorporated in an almost reticular pattern as showed in FIG. 2 can be obtained on the object 30. The destiny of the plural pattern areas 12b . . . 12b incorporated into the optical diffraction structure part 12a can be set in suitable to the purpose, in a range that at least one pattern area 12b is included in one dot 12c such as 50%, 25%, and 6%. FIG. 7A shows the case where plural pattern areas 12b-1 . . . 12b-1 are provided with the density smaller than the case of FIG. 2. When the plural pattern areas 12b . . . 12b are incorporated into the optical diffraction structure part 12a such that a repeated pattern is drawn, it is preferable that at least one repeat unit of the repeated pattern is included in one dot 12c.

The transfer layer 12 can be obtained by executing an aluminum evaporation to the object 30 after the first transfer process and the second transfer process. And, by adhering to layer the release layer 11, the transfer layer 12, and the adhesion layer 13 sequentially on the substrate sheet 10, the optical diffraction structure transfer sheet 1 is manufactured. Each of the substrate sheet 10, the release layer 11, and the adhesion layer 13 can be manufactured in a conventional method. Also, a conventional method can be applied as the method for adhering between the layers. The layer thickness of each layer composing the optical diffraction structure transfer sheet 1 is the following: the substrate sheet 10: 6 μm, the release layer 11: 0.5 μm, the transfer layer 12: 0.5 μm, and the adhesion layer 13: 0.2 μm.

The present invention is not limited to the above mentioned embodiment, and can be executed in various embodiments. For example, the type of the energy beam, the layer thickness of each layer composing the optical diffraction structure transfer sheet 1, the depth of carving pattern, or the like is changeable appropriately. It is not necessary that the shape of the pattern area 12b is a square, and it does not matter which shape of the pattern area 12b is as long as the pattern area 12b is invisible to the naked eyes. For example, like a pattern area 12b-2 showed in FIG. 7B, a round shape can be applied.

As mentioned above, the convexoconcave pattern of the pattern area 12b can be any pattern as long as the convexoconcave pattern of the pattern area 12b can be discriminated to be different from the convexoconcave pattern of the optical diffraction structure part 12a. Therefore, the convexoconcave pattern of the optical diffraction structure part 12a is not limited to an even pattern, and can be, for example, interference fringes to generate a predetermined shape. In this case, the pattern area 12b can be discriminated by forming a particular convexoconcave pattern to the pattern area 12b.

With respect to the optical diffraction structure transfer sheet 1, the layers except for the substrate sheet 10 and the transfer layer 12 are not limited to the above embodiment, and can be deleted, and another layer can be added. For example, another layer such as a back slipping layer for enhancing a slip property of the thermal head, a protection layer for protecting the transferred transfer layer 12, and a heat resistance layer for enhancing a heat resistance property of the substrate sheet 10 can be provided. It is not necessary to provide the release layer 11 in the case where the release property of the substrate sheet 10 is enough. In the case where the release property of the substrate sheet 10 is not enough, the heat residence layer can be provided to the opposite side to the release layer. Also, in the object 30, another layer can be provided between the substrate layer 32 and the melt layer 31.

1. An optical diffraction structure transfer sheet in which a transfer layer were optical diffraction structure having a first pattern is formed, is layered on a substrate sheet, wherein
the optical diffraction structure has a pattern area where a second pattern different from the first pattern is formed, the pattern area being incorporated into the optical diffraction structure in a size invisible to naked eye.

2. The optical diffraction structure transfer sheet according to claim 1, wherein the second pattern is different from the first pattern in a diffraction direction of light.

3. The optical diffraction structure transfer sheet according to claim 1, wherein the second pattern is different from the first pattern in a length between adjacent interference fringes.

4. The optical diffraction structure transfer sheet according to claim 1, wherein
the pattern areas each of which has the second pattern equally, are incorporated into the optical diffraction structure.

5. The optical diffraction structure transfer sheet according to claim 4, wherein
the plural pattern areas are incorporated in accordance with a predetermined regularity in the optical diffraction structure having a plane pattern.

6. A method for manufacturing an optical diffraction structure transfer sheet in which a transfer layer where optical diffraction structure having a first pattern is formed, is layered on a substrate sheet, wherein
the process of manufacturing the transfer process includes a first transfer process and a second transfer process, the first transfer process for transfer the first pattern to the melt layer by the steps:
superposing an object having a melt layer layered on a substrate layer and a first original plate where optical diffractions structure having the first pattern;
irradiating energy beam to a portion of superposition to melt the melt layer by heat based on the energy beam; and
moving the energy beam,
the second transfer process for transferring a second pattern to the melt layer with a size invisible to naked eyes by the steps:
the melt layer of the object where the first pattern is transferred and a second original plate having the second pattern different from the first pattern;
irradiating energy beam to a portion of superposition to melt the melt layer by heat based on the energy beam; and
moving the energy beam,
and further includes a process for layering the object on the substrate sheet as the transfer layer.
